(19) United States
(12) Patent Application Publication
(10) Pub. No.: US 2026/0295785 A1
(43) Pub. Date: Oct. 1, 2026

(54) BIT HOLDER

(71) Applicant: APEX BRANDS, INC., Apex, NC (US)

(72) Inventor: Matthew James KELLER, Urbana, OH (US)

(21) Appl. No.: 19/479,394

(22) PCT Filed: Apr. 26, 2024
(86) PCT No.: PCT/US2024/026434

§ 371 Date: Oct. 28, 2025

Related U.S. Application Data
(60) Provisional application No. 63/462,765, filed on Apr. 28, 2023.

(51) Int. Cl. B25B 23/00; B25B 21/02

(52) U.S. Cl. CPC B25B 23/0035; B25B 21/02

(57) ABSTRACT

A bit holder may include a coupling portion which may operably couple the bit holder to the driving device, a shank which may extend along an axis of rotation to operably couple to a bit, and a torque adjustment assembly for adjusting a maximum amount of torque in the bit holder. The torque adjustment assembly may include a transfer body which may be operably coupled to a shank of the bit holder, a transfer sleeve which may receive torque from the transfer body, and an adjustment sleeve which may be operably coupled to both the transfer body and the transfer sleeve and may adjust the maximum amount of torque transferred from the transfer body to the transfer sleeve. The adjustment sleeve may adjust the maximum amount of torque by moving the transfer sleeve relative to the transfer body axially along an axis of rotation of the bit holder.

### TECHNICAL FIELD

Example embodiments generally relate to power equipment and, more particularly, relate to improvements for a bit holder.

### BACKGROUND

Driving devices are commonly used in both commercial and private settings both to bore holes of various sizes and purposes into lumber or other working media, and to drive fasteners and other forms of hardware into lumber or other working media. Typically employed in a construction setting, driving devices often have an electric or pneumatic motor that applies torque to an attachment that may either be a bit holder or an adapter configured to operably couple the driving device to a fastener, to rotate the respective attachment at relatively high speeds. Such adapters may commonly be referred to as a bit holder. Thus the driving device may exert high amounts of torque onto the bit holder operably coupled to the driving device. In some cases, driving devices may also deliver impacts to the bit holder operably coupled to the driving device in order to drive a fastener quicker. These impacts may increase the amount of torque delivered to the bit holder even further.

Over extended periods of time, and as a result of the driving device applying high levels of torque, and in some cases impacts, bit holders are often subjected to high torsional loads and high shear stresses that can reduce the functional life span of the bit holder. Thus, creating a bit holder that can better manage and control torsional loads experienced during operation may allow for a more favorable overall experience than other bit holders could produce, as well as improve the longevity of the bit holder and any bits used in the bit holder.

### BRIEF SUMMARY OF SOME EXAMPLES

Some example embodiments may provide for a torque adjustment assembly for adjusting a maximum amount of torque in a bit holder. The torque adjustment assembly may include a transfer body which may be operably coupled to a shank of the bit holder, a transfer sleeve which may be operably coupled to the transfer body and may receive torque from the transfer body, and an adjustment sleeve which may be operably coupled to both the transfer body and the transfer sleeve and may adjust the maximum amount of torque transferred from the transfer body to the transfer sleeve. The adjustment sleeve may adjust the maximum amount of torque by changing a position of the transfer sleeve relative to the transfer body axially along an axis of rotation of the bit holder.

In another example embodiment, a bit holder for use with a driving device may be provided. The bit holder may include a coupling portion which may operably couple the bit holder to the driving device, a shank which may extend away from the coupling portion along an axis of rotation to operably couple to a bit, and a torque adjustment assembly for adjusting a maximum amount of torque that may be transferred to a bit from the driving device. The torque adjustment assembly may include a transfer body which may be operably coupled to a shank of the bit holder, a transfer sleeve which may be operably coupled to the transfer body and may receive torque from the transfer body, and an adjustment sleeve which may be operably coupled to both the transfer body and the transfer sleeve and may adjust the maximum amount of torque transferred from the transfer body to the transfer sleeve. The adjustment sleeve may adjust the maximum amount of torque by changing a position of the transfer sleeve relative to the transfer body axially along an axis of rotation of the bit holder.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of a bit holder according to an example embodiment;

FIG. 2 illustrates a perspective view of the bit holder in an assembled view in accordance with an example embodiment;

FIG. 3 illustrates a perspective view of the bit holder in an exploded view in accordance with an example embodiment;

FIG. 4 illustrates a perspective view of the shank and the coupling portion according to an example embodiment;

FIG. 4 illustrates a perspective view of a portion of a shank of a bit holder in accordance with an example embodiment;

FIG. 5 illustrates a perspective view of the transfer body according to an example embodiment;

FIG. 6 illustrates a perspective view of the transfer sleeve in accordance with an example embodiment;

FIG. 7 illustrates a perspective view of the operable coupling between the transfer body and the transfer sleeve according to an example embodiment;

FIG. 8 illustrates a perspective view of the adjustment sleeve in accordance with an example embodiment;

FIG. 9 illustrates a section view of the adjustment sleeve according to an example embodiment; and

FIG. 10 illustrates a close up section view of the torque adjustment assembly in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments may provide a bit holder having a coupling portion, a shank, and a torque adjustment assembly. The shank may further have a torsion release neck which may be designed to absorb torsional energy through angular deflection. The torsion release neck may have a smaller diameter than other portions of the shank. The torque adjustment assembly may allow for the user of the bit holder to decide the upper limit of how much torque is transferred from the driving device to the bit. As will be discussed below, the adjustment of how much torque passes through the bit holder may allow for the bit holder to have improved performance and overall improved durability. Other improvements may also be possible, and the improvements can be made completely independent of each other, or in combination with each other in any desirable configuration. Accordingly, the operability and utility of the bit holder may be enhanced or otherwise facilitated.

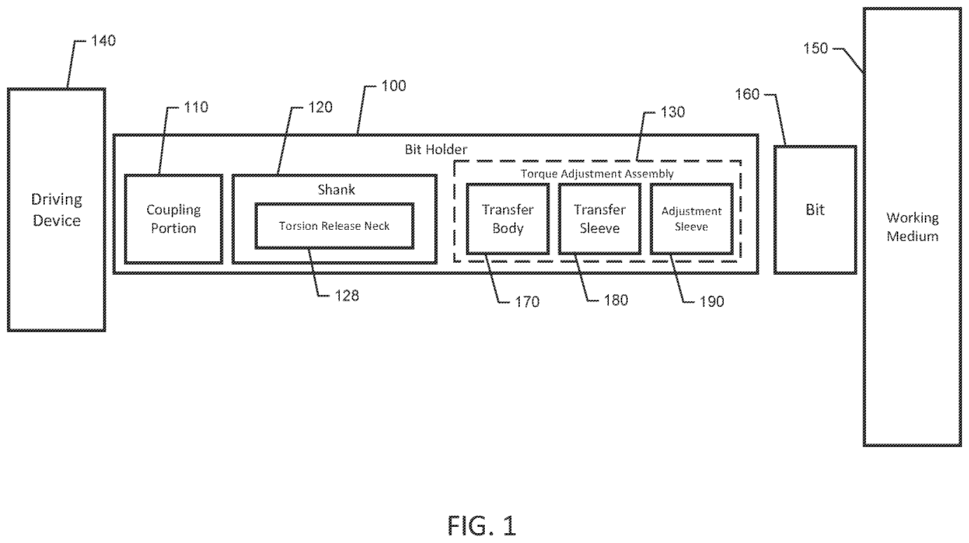

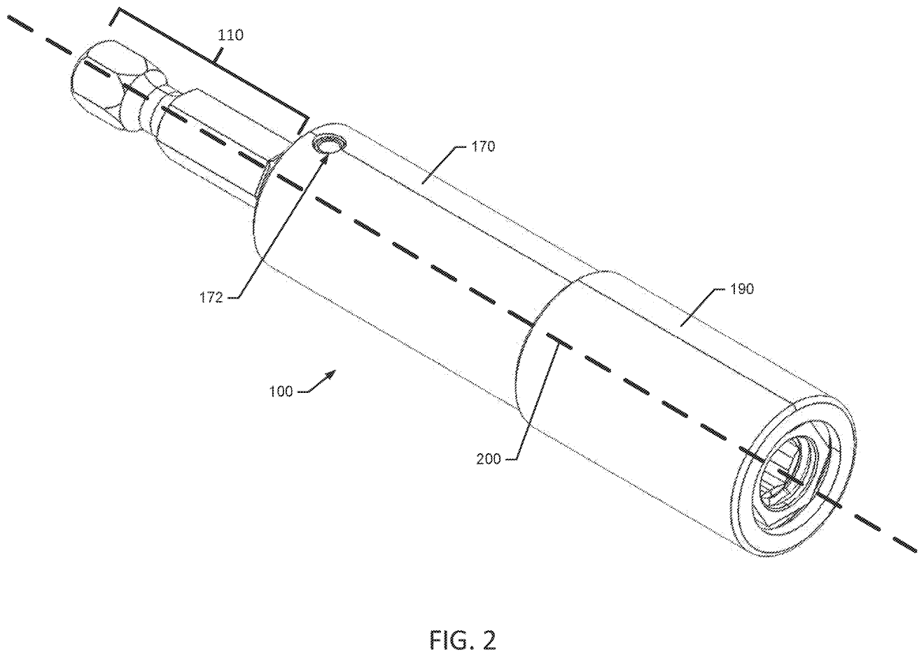

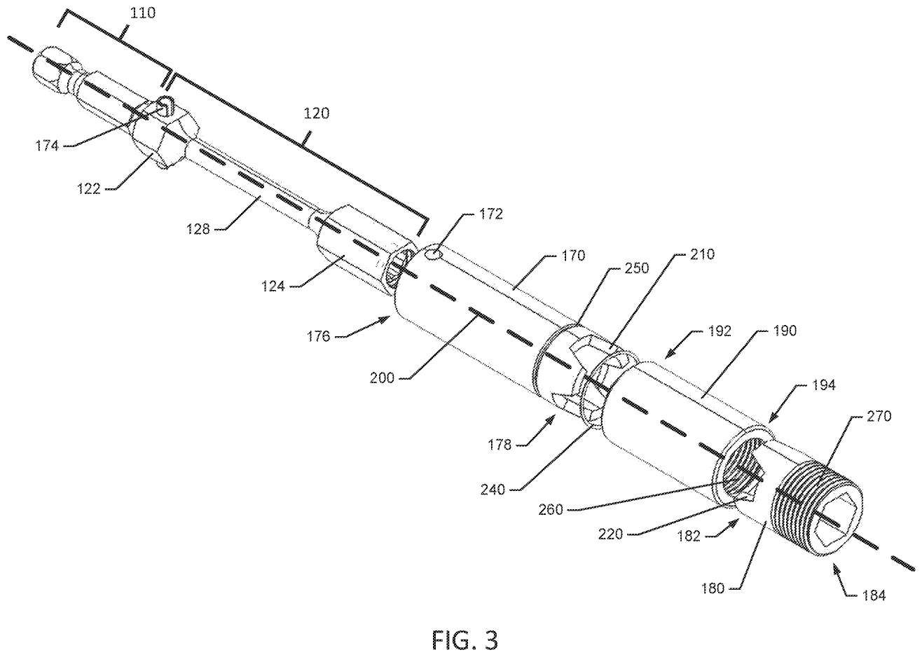

FIG. 1 illustrates a block diagram of a bit holder 100 according to an example embodiment. FIGS. 2 and 3 illustrate perspective views of the bit holder 100 in assembled and exploded views, respectively, according to example embodiments. As shown in FIGS. 1-3, the bit holder 100 may include a coupling portion 110, a shank 120, and a torque adjustment assembly 130. The coupling portion 110 may operably couple the bit holder 100 to a driving device 140. In this regard, the coupling portion 110 may be a part of the bit holder 100 that actively receives a driving force. In some embodiments, the driving device 140 may be a handheld power tool such as a drill or an impact driver. The coupling portion 110 of the bit holder 100 may therefore assist with translating torque from the driving device 140 into rotational motion of the bit holder 100. The driving device 140 may also be securely operably coupled with the coupling portion 110 such that the bit holder 100 doesn't become uncoupled from the driving device 140 due to forces exerted on the bit holder 100 by a working medium 150. In some embodiments, the working medium 150 may be wood or any suitable material which may be capable of being worked on by the driving device 140. In some embodiments, the coupling portion 110 of the bit holder 100 may have a non-circular outer surface to facilitate translating torque from the driving device 140 to the rest of the bit holder 100. For example, the coupling portion 110 may have a hexagonally shaped cross section to facilitate engagement with a chuck of a driving device 140 such as a drill.

The shank 120 may operably couple the coupling portion 110 to the torque adjustment assembly 130 as well as to the bit 160. Thus, the shank 120, may assist with translating torque from the driving device 140 into rotational motion of the bit 160, along with the torque adjustment assembly 130 in some embodiments. The coupling portion 110 may be disposed at a first end 122 of the shank 120 and the bit 160 may be operably coupled to a second end 124 of the shank 120 which may comprise a receptacle formed therein for operably coupling to the bit 160. Therefore, the shank 120 may be subject to high torsional loading due to the shank 120 forming the connection between the coupling portion 110 and the bit 160, both of which may experience opposing forces while the bit holder 100 is in use. In this regard, the driving device 140 may exert a torque on the coupling portion 110 and the working medium 150 may exert a frictional force against the bit 160, or against a fastener operably coupled to the bit 160, that may oppose the direction of rotation of the bit holder 100. Thus, these opposing forces may be naturally distributed throughout the bit holder 100 and its components such as the shank 120 and the torque adjustment assembly 130. In this regard, the torque adjustment assembly 130 may allow a user of the driving device 140 and bit holder 100 to adjust a maximum amount of torque that may be transferred to the bit 160 from the driving device 140.

As shown in FIG. 3, the torque adjustment assembly 130 may include a transfer body 170, a transfer sleeve 180, and an adjustment sleeve 190. In an example embodiment, all of the coupling portion 110, the shank 120, the transfer body 170, the transfer sleeve 180 and the adjustment sleeve 190 may be coaxially disposed along an axis of rotation 200 of the bit holder 100. In some cases, the transfer body 170 may be operably coupled to the shank 120 at a first end 122 of the shank 120. According to an example embodiment, the transfer body 170 may be a substantially cylindrical tube-like member with a hollow central region. In this regard, the transfer body 170 may include a transfer body bore 172 extending from an exterior surface of the transfer body 170, through a wall of the transfer body 170, to an interior surface of the transfer body 170. In other words, the transfer body bore 172 may provide a pass-through from outside the transfer body 170 to the hollow central region of the transfer body 170. In some cases, the shank 120 may also include a shank bore 126 which may be disposed at the first end 122 and in an example embodiment, may extend entirely through the shank 120. The transfer body 170 may accordingly be operably coupled to the shank 120 responsive to sliding the shank 120 axially into the hollow central region of the transfer body 170 until the shank bore 126 aligns with the transfer body bore 172. Responsive to the alignment of the respective bores (126, 172), a pin 174 may be inserted through both the transfer body 170 and the shank 120 via their respective bores (172, 126) in order to operably couple the transfer body 170 to the shank 120. As such, the shank 120 may transfer torque from the driving device 140 to the transfer body 170 via the pin 174. In some cases, the pin 174 may extend fully through both the shank 120 and the transfer body 170. In some other cases, the pin 174 may not pass entirely through the shank 120 and the transfer body 170, and may instead seat itself within the shank 120 or the transfer body 170.

In some cases, the transfer sleeve 180 may be operably coupled to the transfer body 170 to receive torque from the transfer body 170. The transfer sleeve 180 may also be operably coupled to the shank 120 at the second end 124, proximate to where the bit 160 may be seated in the shank 120. In this regard, the transfer sleeve 180, similar to the transfer body 170, may also be a substantially cylindrical tube-like member with a hollow central region. However, the transfer sleeve 180 may have an interior surface that may be shaped to compliment the exterior surface of the shank 120. For instance, in some embodiments, the second end 124 of the shank 120 may have a hexagonal cross section shape. In such cases, the interior surface of the transfer sleeve 180 may also have a hexagonal cross section shape. This may allow the shank 120 to operably couple to the transfer sleeve 180 by axially sliding into the hollow central region of the transfer sleeve 180. The transfer sleeve 180 may thus also be translatable axially along the axis of rotation 200 relative to the transfer body 170. In this regard, the position of the transfer sleeve 180 may be adjusted by the adjustment sleeve 190, which may be operably coupled to both the transfer body 170 and the transfer sleeve 180. As mentioned above and discussed in greater detail below, the adjustment sleeve 190 may adjust the maximum amount of torque that is transferred from the transfer body 170 to the transfer sleeve 180. This may be accomplished by adjusting the position of the transfer sleeve 180 axially along the axis of rotation 200 relative to the transfer body 170.

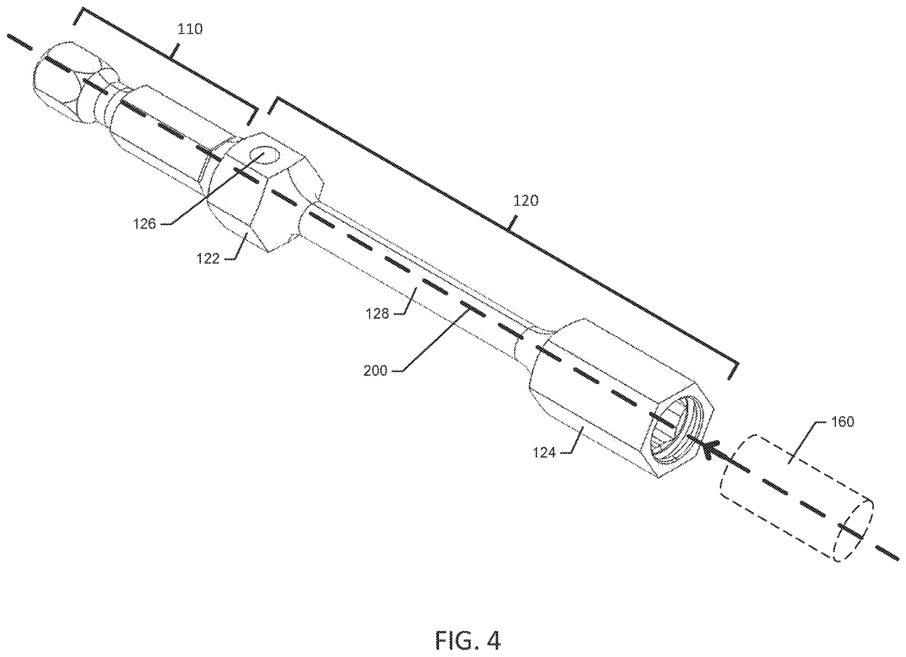

FIG. 4 depicts a perspective view of the shank 120 and the coupling portion 110 according to an example embodiment. The shank 120 of some example embodiments may further include a torsion release neck 128. The torsion release neck 128 may be a neck in the shank 120 which may have a smaller diameter than both the first end 122 and the second end 124 of the shank 120. As a result of the torsion release neck 128 having a smaller diameter than the first end 122 and the second end 124 of the shank 120, the torsion release neck 128 may have a lower mathematical value for its polar moment of inertia than other portions of the bit holder 100. In this regard, the torsion release neck 128 may be the part of the bit holder 100 that is least resistant to torsional loading. As such, the torsion release neck 128 may help preserve the functionality of the bit holder 100 by reducing the maximum amount of torque that may be transferred to the bit 160 from the driving device 140.

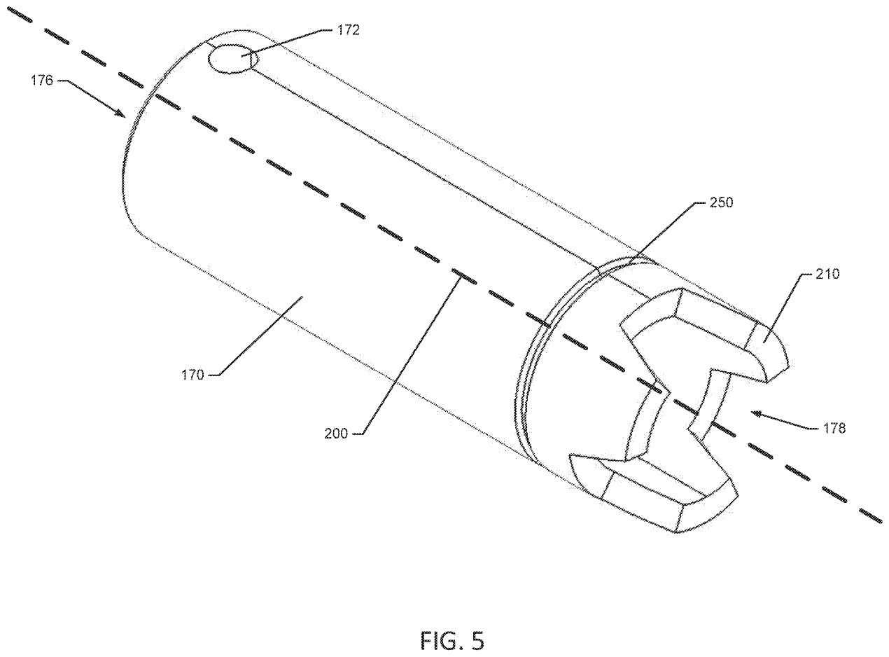

To accomplish this, the shank 120 may angularly deflect at the torsion release neck 128 responsive to the bit holder 100 experiencing relatively high maximum amounts of torque. In other words, the torsion release neck 128 may absorb some of the torsional energy applied to the bit holder 100 through angular deflecting, rather than pass all of the torsional energy straight through to the bit 160. For example, in some cases where the driving device 140 may be an impact driver, the torsion release neck 128 may allow a significant angular deflection to occur, which may distribute each impact blow from the driving device 140 over a longer period of time and lower the peak torque experienced by the installed bit 160. In an example embodiment, the angular deflection of the shank 120 may occur between the first and second ends (122, 124) of the shank 120. In other words, the first end 122 of the shank 120 may be proximate to the coupling portion 110, and may thus rotate almost entirely in direct correlation to the rotation of the driving device 140. Meaning for every degree the driving device 140 output component rotates, the first end 122 of the shank 120 may rotate the same amount. The second end 124 of the shank 120, however, may not necessarily rotate in direct correlation to the first end 122. This may be due to the angular deflection of the shank 120, where for example, the first end 122 may rotate further than the second end 124. In this regard, the torsion release neck 128 may also assist with reducing the likelihood of the bit holder 100 experiencing material failures (i.e. cracking or chipping) and may generally improve the lifespan of the bit holder 100. Thus, the bit holder 100 as a whole may exhibit improved durability and better performance as a result of the torsion release neck 128 reducing torsional loading. As mentioned above, the torque adjustment assembly 130 may allow the user to adjust the maximum amount of torque applied to the bit 160. This may be accomplished by controlling the amount of angular deflection of the shank 120, the details of which will be discussed below in relation to FIGS. 5-10.

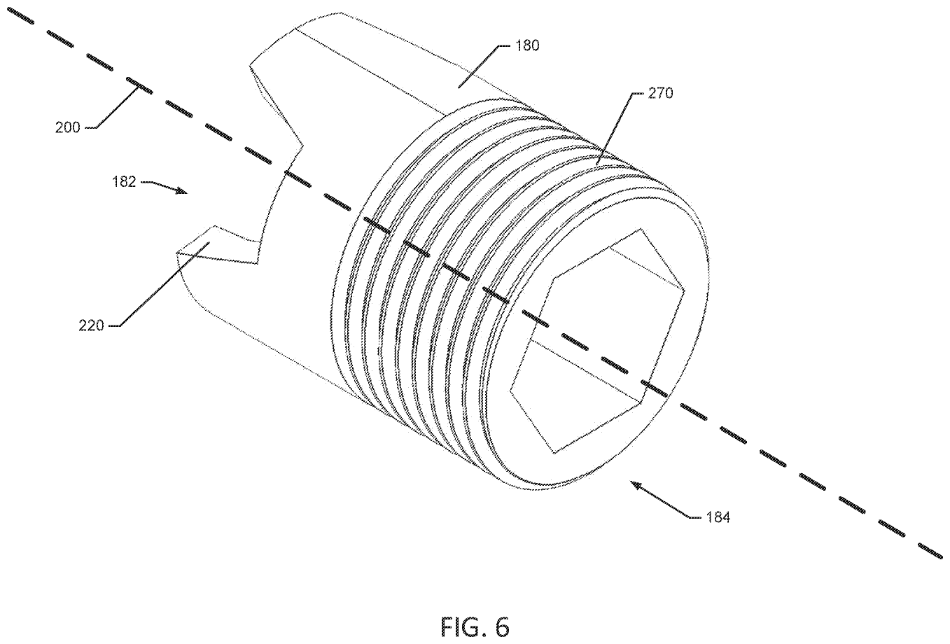

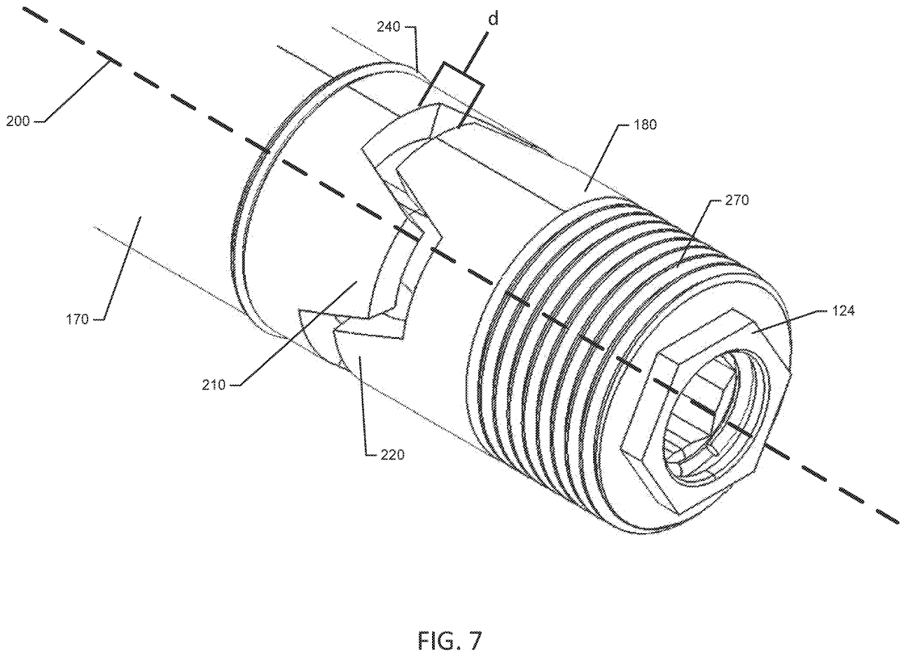

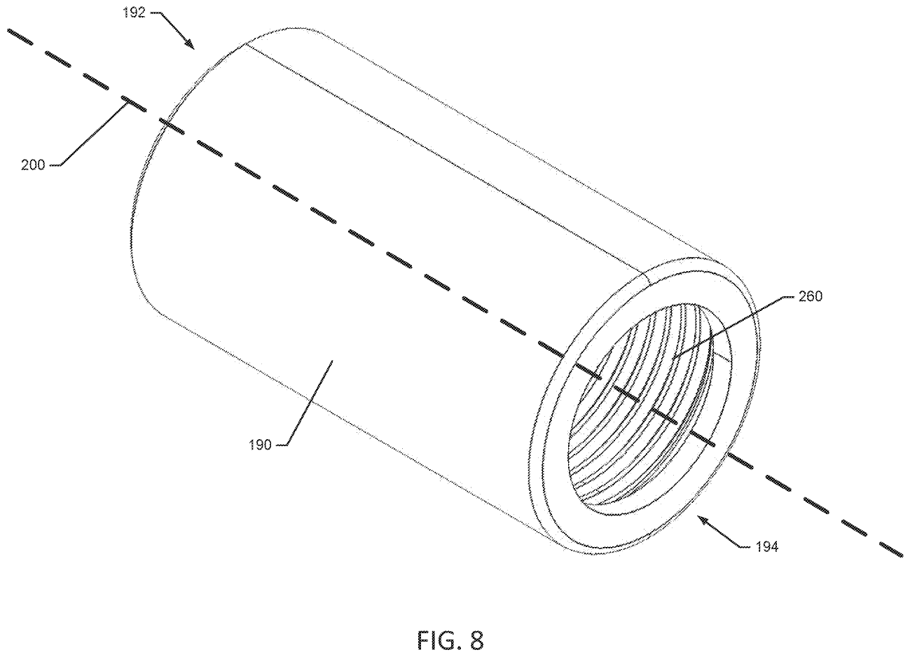

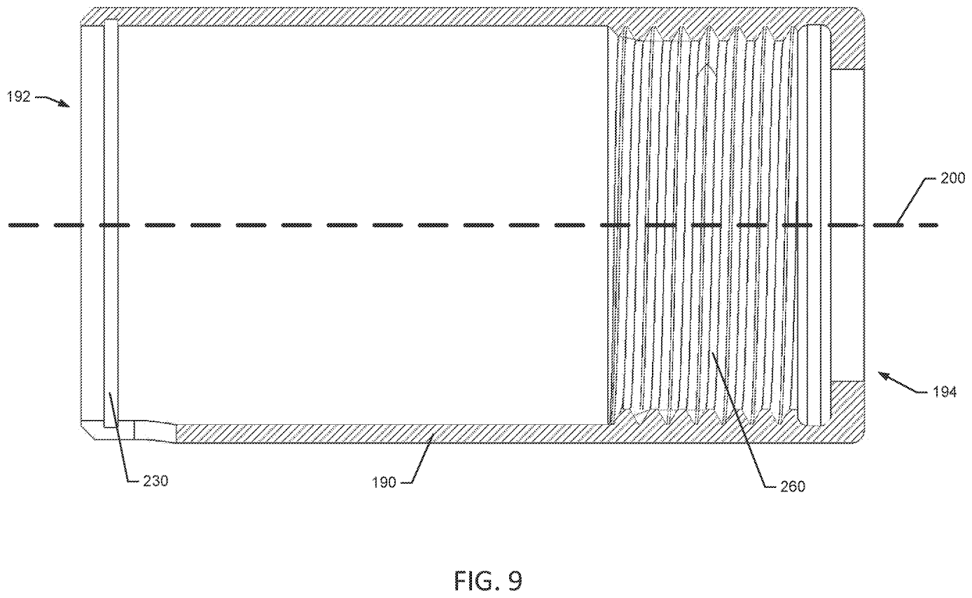

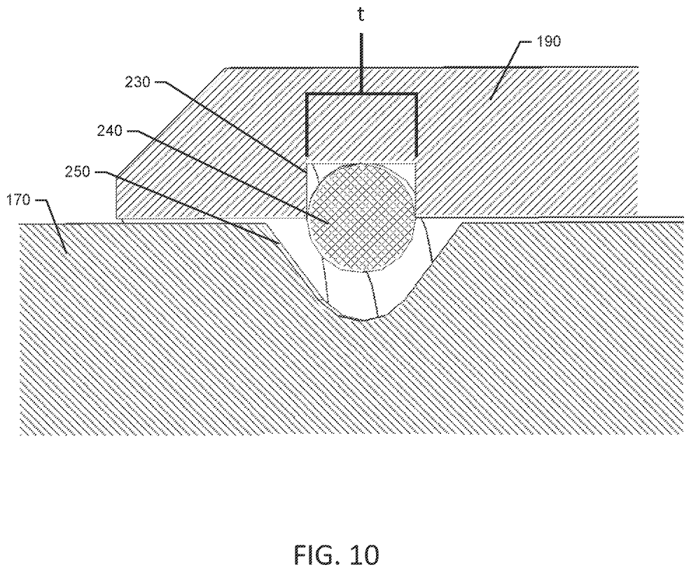

FIG. 5 illustrates a perspective view of the transfer body 170 according to an example embodiment. FIG. 6 illustrates a perspective view of the transfer sleeve 180 in accordance with an example embodiment. FIG. 7 illustrates a perspective view of the operable coupling between the transfer body 170 and the transfer sleeve 180 according to an example embodiment. FIG. 8 illustrates a perspective view of the adjustment sleeve 190 in accordance with an example embodiment. FIG. 9 illustrates a section view of the adjustment sleeve 190 according to an example embodiment. FIG. 10 illustrates a close up section view of the torque adjustment assembly 130 in accordance with an example embodiment.

Referring now to FIGS. 5-10, the torque adjustment assembly 130 will be described in greater detail. In an example embodiment, the transfer body 170 may be operably coupled to the shank 120 at a first end 176 of the transfer body 170 and operably coupled to the transfer sleeve 180 at a second end 178 of the transfer body 170. Responsive to being operably coupled to the shank 120 via the pin 174, the transfer body 170 may not move axially or angularly relative to the shank 120. In some cases, the transfer sleeve 180 may be operably coupled to the transfer body 170 at a first end 182 of the transfer sleeve 180 and operably coupled to the adjustment sleeve 190 at a second end 184 of the transfer sleeve 180. In contrast to the transfer body 170, the transfer sleeve 180 may move axially relative to the shank 120, but may not move angularly relative to the shank due to being operably coupled with the second end 124 of the shank 120 in the central region of the transfer sleeve 180. The movement of the transfer sleeve 180 may thus be limited to axial movement along the axis of rotation 200, and the movement may be induced by the adjustment sleeve 190. In an example embodiment, the transfer body 170 may include a first set of teeth 210 disposed at the second end 178 of the transfer body 170 and the transfer sleeve 180 may include a second set of teeth 220 disposed at the first end 182 of the transfer sleeve 180. In some cases, the first set of teeth 210 may operably couple with the second set of teeth 220 to transfer torque to the transfer sleeve 180 from the transfer body 170. The axial movement of the transfer sleeve 180 relative to the shank 120 via the adjustment sleeve 190 may move the first and second sets of teeth (210, 220) into and out of engagement with each other as desired. The torque adjustment assembly 130 may thus be operable in a first mode 280 in which the first and second sets of teeth (210, 220) are not in direct contact with each other, and a second mode 290 in which the first and second sets of teeth (210, 220) are in direct contact with each other.

Accordingly, the adjustment sleeve 190 may be operably coupled to an exterior surface of both the transfer body 170 and the transfer sleeve 180. In this regard, the adjustment sleeve 190 may include a first groove 230, that may extend around a circumference of the interior surface of the adjustment sleeve 190, and a retaining ring 240 that may be disposed within the first groove 230. In some embodiments, the first groove 230 may be disposed toward a first end 192 of the adjustment sleeve 190, and may be formed or machined into the adjustment sleeve 190 such that a depth of the first groove 230 may not be greater than a thickness (t) of the retaining ring 240 (i.e. a diameter of the cross section of the retaining ring 240). In this regard, while the retaining ring 240 may be operably coupled to the first groove 230, the retaining ring 240 may extend out of the first groove 230 and into the hollow central region of the adjustment sleeve 190. In other words, part of the thickness of the retaining ring 240 may be disposed within the first groove 230 and another part of the thickness of the retaining ring 240 may be disposed outside the first groove 230, in the central region of the adjustment sleeve 190.

As such, the part of the retaining ring 240 that may be disposed outside of the first groove 230 may operably couple to a second groove 250 that may extend around an exterior surface of the transfer body 170 towards the second end 178 of the transfer body 170 proximate to the first set of teeth 210. Similar to the first groove 230, the second groove 250 may be formed or machined into the transfer body 170. In some cases, a depth of the second groove 250 may be greater than the thickness of the retaining ring 240, and in other cases the depth of the second groove 250 may be less than the thickness of the retaining ring 240. Regardless of the depth of the second groove 250, when added together, the depth of the first groove 230 added to the depth of the second groove 250 may be greater than the thickness of the retaining ring 240. Thus, the retaining ring 240 may operably couple the adjustment sleeve 190 to the transfer body 170 via the first and second grooves (230, 250) such that the adjustment sleeve 190 may be rotatable around the axis of rotation 200 relative to the transfer body 170.

In some cases, the adjustment sleeve 190 may further include a first thread assembly 260 that that may extend around the circumference of the interior surface of the adjustment sleeve 190 at a second end 194 of the adjustment sleeve 190. The first thread assembly 260 may operably couple to a second thread assembly 270 disposed at the second end 184 of the transfer sleeve 180. In this regard, the adjustment sleeve 190 may be rotatably operably coupled to both the transfer sleeve 180 and the transfer body 170. However, the rotatable operable coupling between the transfer body 170 and the adjustment sleeve 190 may not allow for the axial movement of the adjustment sleeve 190 and the transfer body 170 relative to each other. On the other hand, the rotatable operable coupling between the adjustment sleeve 190 and the transfer sleeve 180 may necessarily move the transfer sleeve 180 axially relative to the adjustment sleeve 190 and the transfer body 170. This axial motion may be induced by the first and second thread assemblies (260, 270) that operably couple the respective components together. In this regard, the user of the driving device 140 and thus of the torque adjustment assembly 130 may rotate the adjustment sleeve 190 clockwise to move the transfer sleeve 180 away from the transfer body 170, or counter-clockwise to move the transfer sleeve 180 towards the transfer body 170.

The ability to adjust the position of the transfer sleeve 180 relative to the transfer body 170 may mean the torque adjustment assembly 130 may be operable in two modes: the first mode 280 in which the transfer sleeve 180 may be disposed a distance (d) apart from the transfer body 170, and the second mode 290 in which the transfer sleeve 180 may be in contact with the transfer body 170. In other words, in the first mode 280, the first set of teeth 210 may not engage with the second set of teeth 220 immediately. There may be the distance (d) between the transfer body 170 and the transfer sleeve 180 that may separate the first set of teeth 210 from the second set of teeth 220. On the other hand, in the second mode 290, the first set of teeth 210 and the second set of teeth 220 may be engaged and thus in contact with one another at all times. In this regard, adjusting the adjustment sleeve 190 may adjust the distance (d) between the transfer sleeve 180 and the transfer body 170, which may affect the amount of angular displacement that the shank 120 experiences, which may thus affect the maximum amount of torque in the bit holder 100. Therefore, as will be described below, in the first mode 280, the maximum amount of torque in the bit holder 100 may be less than in the second mode 290.

In the first mode 280, the shank 120 may transfer torque directly to the bit 160. As described above in reference to FIG. 4, the shank 120 may deflect angularly due to the inclusion of the torsion release neck 128, which may reduce the maximum amount of torque delivered to the bit 160 by absorbing some of the torsional energy through angular deflection of the shank 120. The angular deflection of the shank 120 may distribute energy from the driving device 140 over a larger time which may lower the maximum amount of torque in the bit holder 100. Responsive to the torque adjustment assembly 130 being in the first mode 280, the amount of angular deflection of the shank 120 may be based on the distance (d) between the transfer sleeve 180 and the transfer body 170, which of course may be adjusted by rotating the adjustment sleeve 190. In other words, the shank 120 may angularly deflect up until the first set of teeth 210 may come into contact with the second set of teeth 220. At this point, the shank 120 can absorb no more torsional energy through angular deflection because the transfer body 170 may begin to transfer torque to the transfer sleeve 180 via the first and second sets of teeth (210, 220).

As such, in the first mode 280, the maximum amount of torque in the bit holder 100 may be limited as a result of the user defining the distance (d) between the transfer sleeve 180 and the transfer body 170 via the rotation of the adjustment sleeve 190. Responsive to the distance (d) increasing, the shank 120 may experience greater angular deflection prior to the first and second sets of teeth (210, 220) engaging with one another. Responsive to the distance (d) decreasing, the shank 120 may experience less angular deflection prior to the first and second sets of teeth (210, 220) engaging with one another. The angular deflection of the shank 120 may increase proportionally with the distance (d) between the transfer sleeve 180 and the transfer body 170. Thus, when the first and second sets of teeth (210, 220) are separated by a maximum distance (d), a greatest amount of energy is absorbed by the shank 120 and the maximum amount of torque in the bit holder 100 may be at a minimum value. In some cases, the clockwise rotation of the adjustment sleeve 190 may increase the life of the bit holder 100 by reducing the maximum amount of torque in the bit holder 100. On the other hand, the counter-clockwise rotation of the adjustment sleeve 190 may decrease the life of the bit holder 100 by increasing the maximum amount of torque in the bit holder 100.

The proportional relationship of the distance (d) and the angular deflection of the shank 120 may be due to an angle of the first and second sets of teeth (210, 220). In this regard, each individual tooth of the first and second sets of teeth (210, 220) may be formed at an angle relative to the transfer body 170 and the transfer sleeve 180, respectively. The angle at which each tooth of the first set of teeth 210 is formed may be the same angle at which each tooth of the second set of teeth 220 is formed, so that the first and second sets of teeth (210, 220) are able to engage each other completely complementarily. For example, if the angle of each tooth is measured relative to the axis of rotation 200 of the bit holder 100, then the greater the angle of each tooth in the first and second sets of teeth (210, 220) is, the greater amount of angular deflection of the shank 120 may occur before the first and second sets of teeth (210, 220) engage with one another. In an example embodiment, the angle of each tooth in the first and second sets of teeth (210, 220) may be within a range of approximately 5° to approximately 25°, and in some embodiments may be approximately 15°.

On the other hand, the torque adjustment assembly 130 may enter the second mode 290 responsive to the user tightening the adjustment sleeve 190 until the transfer sleeve 180 may be in contact with the transfer body 170, and the first and second sets of teeth (210, 220) may be completely engaged without any angular deflection of the shank 120. The transfer body 170 and the transfer sleeve 180, together, may provide a much greater stiffness than the shank 120 alone, and may thus reduce the time that energy from the driving device 140 must be absorbed, which may greatly increase the maximum amount of torque in the bit holder 100. Thus, in the second mode 290, the transfer body 170 and the transfer sleeve 180 may transfer torque to the bit 160 disposed in the bit holder 100 via the first and second sets of teeth (210, 220) without angular deflection of the shank 120, which may increase the maximum amount of torque in the bit holder 100. Responsive to the first and second sets of teeth (210, 220) being fully engaged, the bit holder 100 may become maximally stiff, and thus the least amount of energy may be absorbed by the shank 120 and the maximum amount of torque in the bit holder 100 may be at a greatest amount.

Some example embodiments may provide for a torque adjustment assembly for adjusting a maximum amount of torque in a bit holder. The torque adjustment assembly may include a transfer body which may be operably coupled to a shank of the bit holder, a transfer sleeve which may be operably coupled to the transfer body and may receive torque from the transfer body, and an adjustment sleeve which may be operably coupled to both the transfer body and the transfer sleeve and may adjust the maximum amount of torque transferred from the transfer body to the transfer sleeve. The adjustment sleeve may adjust the maximum amount of torque by changing a position of the transfer sleeve relative to the transfer body axially along an axis of rotation of the bit holder.

The torque adjustment assembly of some embodiments may include additional features, modifications, augmentations and/or the like to achieve further objectives or enhance performance of the torque adjustment assembly. The additional features, modifications, augmentations and/or the like may be added in any combination with each other. Below is a list of various additional features, modifications, and augmentations that can each be added individually or in any combination with each other. For example, the transfer body may be operably coupled to the shank at a first end of the transfer body and may be operably coupled to the transfer sleeve at a second end of the transfer body. In an example embodiment, the transfer sleeve may be operably coupled to the transfer body at a first end of the transfer sleeve and may be operably coupled to the adjustment sleeve at a second end of the transfer sleeve. In some cases, the transfer body may include a first set of teeth disposed at the second end of the transfer body and the transfer sleeve may include a second set of teeth disposed at the first end of the transfer sleeve. In an example embodiment, the first set of teeth may operably couple with the second set of teeth to transfer torque to the transfer sleeve from the transfer body. In some cases, the adjustment sleeve may include a retaining ring disposed in a first groove that may extend around a circumference of an interior surface at a first end of the adjustment sleeve. In an example embodiment, the transfer body may include a second groove that may extend around a circumference of an exterior surface of the transfer body. In some cases, the retaining ring may operably couple the adjustment sleeve to the transfer body via the first and second grooves such that the adjustment sleeve may be rotatable around the axis of rotation relative to the transfer body. In an example embodiment, the adjustment sleeve may further include a first thread assembly which may be disposed on the interior surface at a second end of the adjustment sleeve. In some cases, the first thread assembly may operably couple to a second thread assembly which may be disposed at the second end of the transfer sleeve. In an example embodiment, responsive to rotation of the adjustment sleeve, the transfer sleeve may translate axially relative to the transfer body via the first and second thread assemblies. In some cases, the torque adjustment assembly may be operable in a first mode in which the transfer sleeve may be disposed a distance apart from the transfer body, and a second mode in which the transfer sleeve may be in contact with the transfer body. In an example embodiment, in the first mode, the maximum amount of torque may be less than in the second mode. In some cases, in the first mode the shank may transfer torque directly to the bit and the shank may deflect angularly to reduce the maximum amount of torque delivered to the bit. In an example embodiment, the amount of angular deflection of the shank may be based on the distance between the transfer sleeve and the transfer body and may be adjusted by rotating the adjustment sleeve. In some cases, the shank may angularly deflect until the first set of teeth may come into contact with the second set of teeth. In an example embodiment, the angular deflection of the shank may increase proportionally with the distance between the transfer sleeve and the transfer body due to an angle of the first and second sets of teeth. In some cases, in the second mode the transfer body and the transfer sleeve may transfer torque to the bit disposed in the bit holder via the first and second sets of teeth without any angular deflection of the shank to increase the maximum amount of torque.

Some example embodiments may provide for a bit holder for use with a driving device. The bit holder may include a coupling portion which may operably couple the bit holder to the driving device, a shank which may extend away from the coupling portion along an axis of rotation to operably couple to a bit, and a torque adjustment assembly for adjusting a maximum amount of torque in the bit holder. The torque adjustment assembly may include a transfer body which may be operably coupled to a shank of the bit holder, a transfer sleeve which may be operably coupled to the transfer body and may receive torque from the transfer body, and an adjustment sleeve which may be operably coupled to both the transfer body and the transfer sleeve and may adjust the maximum amount of torque transferred from the transfer body to the transfer sleeve. The adjustment sleeve may adjust the maximum amount of torque by changing a position of the transfer sleeve relative to the transfer body axially along an axis of rotation of the bit holder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A torque adjustment assembly for adjusting a maximum amount of torque in a bit holder, the torque adjustment assembly comprising:
a transfer body operably coupled to a shank of the bit holder;
a transfer sleeve operably coupled to the transfer body to receive torque from the transfer body; and
an adjustment sleeve operably coupled to both the transfer body and the transfer sleeve and that adjusts the maximum amount of torque transferred from the transfer body to the transfer sleeve, and
wherein the adjustment sleeve adjusts the maximum amount of torque by changing a position of the transfer sleeve relative to the transfer body axially along an axis of rotation of the bit holder.

2. The torque adjustment assembly of claim 1, wherein the transfer body is operably coupled to the shank at a first end of the transfer body and operably coupled to the transfer sleeve at a second end of the transfer body,
wherein the transfer sleeve is operably coupled to the transfer body at a first end of the transfer sleeve and operably coupled to the adjustment sleeve at a second end of the transfer sleeve, and
wherein the transfer body comprises a first set of teeth disposed at the second end of the transfer body and the transfer sleeve comprises a second set of teeth disposed at the first end of the transfer sleeve.

3. The torque adjustment assembly of claim 2, wherein the first set of teeth operably couples with the second set of teeth to transfer torque to the transfer sleeve from the transfer body.

4. The torque adjustment assembly of claim 1, wherein the adjustment sleeve comprises a retaining ring disposed in a first groove that extends around a circumference of an interior surface at a first end of the adjustment sleeve,
wherein the transfer body comprises a second groove that extends around a circumference of an exterior surface of the transfer body, and
wherein the retaining ring operably couples the adjustment sleeve to the transfer body via the first and second grooves such that the adjustment sleeve is rotatable around the axis of rotation relative to the transfer body.

5. The torque adjustment assembly of claim 1, wherein the adjustment sleeve further comprises a first thread assembly disposed on the interior surface at a second end of the adjustment sleeve, and
wherein the first thread assembly operably couples to a second thread assembly disposed at the second end of the transfer sleeve.

6. The torque adjustment assembly of claim 5, wherein responsive to rotation of the adjustment sleeve, the transfer sleeve translates axially relative to the transfer body via the first and second thread assemblies.

7. The torque adjustment assembly of claim 2, wherein the torque adjustment assembly is operable in a first mode in which the transfer sleeve is disposed a distance apart from the transfer body, and a second mode in which the transfer sleeve is in contact with the transfer body, and
wherein in the first mode, the maximum amount of torque is less than in the second mode.

8. The torque adjustment assembly of claim 7, wherein in the first mode the shank transfers torque directly to a bit disposed in the bit holder and the shank deflects angularly to reduce the maximum amount of torque delivered to the bit, and wherein an amount of angular deflection of the shank is based on the distance
between the transfer sleeve and the transfer body and is adjusted by rotating the adjustment sleeve.

9. The torque adjustment assembly of claim 8, wherein the shank angularly deflects until the first set of teeth come into contact with the second set of teeth, and
wherein the amount of angular deflection of the shank increases proportionally with the distance between the transfer sleeve and the transfer body due to an angle of the first and second sets of teeth.

10. The torque adjustment assembly of claim 8, wherein in the second mode the transfer body and the transfer sleeve transfer torque to the bit disposed in the bit holder via the first and second sets of teeth without any amount of angular deflection of the shank to increase the maximum amount of torque.

11. A bit holder for use with a driving device, the bit holder comprising:
a coupling portion to operably couple the bit holder to the driving device;
a shank extending away from the coupling portion along an axis of rotation to operably couple to a bit; and
a torque adjustment assembly for adjusting a maximum amount of torque in the bit holder,
wherein the torque adjustment assembly comprises:
a transfer body operably coupled to a shank of the bit holder;
a transfer sleeve operably coupled to the transfer body to receive torque from the transfer body; and
an adjustment sleeve operably coupled to both the transfer body and the transfer sleeve and that adjusts the maximum amount of torque transferred from the transfer body to the transfer sleeve, and
wherein the adjustment sleeve adjusts the maximum amount of torque by changing a position of the transfer sleeve relative to the transfer body axially along an axis of rotation of the bit holder.

12. The bit holder of claim 11, wherein the transfer body is operably coupled to the shank at a first end of the transfer body and operably coupled to the transfer sleeve at a second end of the transfer body,
wherein the transfer sleeve is operably coupled to the transfer body at a first end of the transfer sleeve and operably coupled to the adjustment sleeve at a second end of the transfer sleeve, and
wherein the transfer body comprises a first set of teeth disposed at the second end of the transfer body and the transfer sleeve comprises a second set of teeth disposed at the first end of the transfer sleeve.

13. The bit holder of claim 12, wherein the first set of teeth operably couples with the second set of teeth to transfer torque to the transfer sleeve from the transfer body.

14. The bit holder of claim 11, wherein the adjustment sleeve comprises a retaining ring disposed in a first groove that extends around a circumference of an interior surface at a first end of the adjustment sleeve,
wherein the transfer body comprises a second groove that extends around a circumference of an exterior surface of the transfer body, and
wherein the retaining ring operably couples the adjustment sleeve to the transfer body via the first and second grooves such that the adjustment sleeve is rotatable around the axis of rotation relative to the transfer body.

15. The bit holder of claim 11, wherein the adjustment sleeve further comprises a first thread assembly disposed on the interior surface at a second end of the adjustment sleeve, and
wherein the first thread assembly operably couples to a second thread assembly disposed at the second end of the transfer sleeve.

16. The bit holder of claim 15, wherein responsive to rotation of the adjustment sleeve, the transfer sleeve translates axially relative to the transfer body via the first and second thread assemblies.

17. The bit holder of claim 12, wherein the torque adjustment assembly is operable in a first mode in which the transfer sleeve is disposed a distance apart from the transfer body, and a second mode in which the transfer sleeve is in contact with the transfer body, and
wherein in the first mode, the maximum amount of torque is less than in the second mode.

18. The bit holder of claim 17, wherein in the first mode the shank transfers torque directly to the bit and the shank deflects angularly to reduce the maximum amount of torque delivered to the bit, and
wherein an amount of angular deflection of the shank is based on the distance between the transfer sleeve and the transfer body and is adjusted by rotating the adjustment sleeve.

19. The bit holder of claim 18, wherein the shank angularly deflects until the first set of teeth come into contact with the second set of teeth, and
wherein the amount of angular deflection of the shank increases proportionally with the distance between the transfer sleeve and the transfer body due to an angle of the first and second sets of teeth.

20. The bit holder of claim 17, wherein in the second mode the transfer body and the transfer sleeve transfer torque to the bit disposed in the bit holder via the first and second sets of teeth without any amount of angular deflection of the shank to increase the maximum amount of torque.
